(19) United States
(12) Patent Application Publication
(10) Pub. No.: US 2006/0183640 A1
(43) Pub. Date: Aug. 17, 2006

(54) Herbicidal composition

(75) Inventors: Toshiro Otsubo, Sanda-shi (JP); Atsushi Watanabe, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/058,246

(22) Filed: Feb. 16, 2005

(51) Int. Cl. A01N 35/10; A01N 25/04

(52) U.S. Cl. 504/344; 504/364

(57) ABSTRACT

A herbicidal composition comprising i) clethodim, ii) a sulfonate surfactant, iii) a polyoxyalkylene alkanolamide surfactant, iv) an aromatic hydrocarbon and optionally v) an ester of fatty acid gives good stability of the emulsion after it is diluted with water.

### FIELD OF THE INVENTION

The present invention relates to a herbicidal composition.

### BACKGROUND ARTS

Some compositions containing a herbicidal cyclohexanedione compound are known in U.S. Pat. No. 4,626,276, U.S. Pat. No. 4,741,768, U.S. Pat. No. 5,084,087 and U.S. Pat. No. 5,554,576.

### SUMMARY OF THE INVENTION

The present invention provides a herbicidal composition comprising i) clethodim, ii) a sulfonate surfactant, iii) a polyoxyalkylene alkanolamide surfactant and iv) an aromatic hydrocarbon.

According to the present invention, the composition containing clethodim can provide a stable emulsion when it is diluted with hard water as well as normal water.

### DETAILED DESCRIPTION OF THE INVENTION

In the present invention, clethodim is an herbicidal ingredient, and the chemical name of clethodim is (±)-2-[(E)-1-[(E)-3-chloroallyloxyimino]propyl]-5- [2-(ethylthio)propyl]-3-hydroxyclclohex-2-enone of the formula: 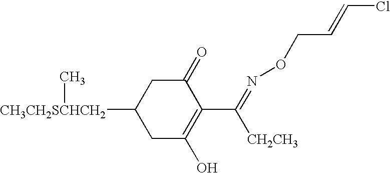
It can be obtained in the market, for example, it is provided by Valent U.S.A. Corporation, Tomen Agro, Inc. or Arvesta Corporation.

The content of clethodim in the herbicidal composition of the present invention is generally 5% to 40% by weight, preferably 10% to 30% by weight.

The sulfonate surfactant means an anionic surfactant having at least one sulfonic acid salt group in the molecule. Examples of the sulfonate surfactant include salts of alkylbenzene sulfonic acid (e.g., (C8-C15 alkyl)benzenesulfonate), salts of alkylnaphthalene sulfonic acid, salts of alkylsulfonic acid, salts of alkyl ether sulfonic acid, salts of fatty alcohol ether sulfonic acid and salts of polyoxyalkylene tristyrylphenyl ether sulfonic acid. Typical examples of the salt are calcium, sodium and potassium salts. Typical examples of the sulfonate are dodecylbenzenesulfonate, diisopropylnaphthalenesulfonate, diisobutylnaphthalenesulfonate, α-olefinsulfonate and dialkylsulfosuccinate. Among them, calcium dodecylbenzenesulfonate, sodium dodecylbenzenesulfonate and potassium dodecylbenzenesulfonate are preferably used.

The content of the sulfonate surfactant in the herbicidal composition of the present invention is generally 0.1% to 10% by weight, preferably 0.1% to 5% by weight.

The polyoxyalkylene alkanolamide surfactant is a nonionic surfactant. It is a polyoxyalkylenated fatty acid amide in general. It is typically given by the formula: RCONH(AO)ₙH or RCON[(AO)ₙH]₂ wherein R is an alkyl group having 6 to 21 carbon atoms, (AO)ₙ is polyoxyethylene, polyoxypropylene or polyoxyethylene polyoxypropylene block copolymer and n is 2 to 20. The RCONH(AO)ₙH type is preferably used. Examples of the polyoxyalkylene alkanolamide surfactant include polyoxyethylene lauramide, polyoxyethylene stearamide, polyoxyethylene cocamide, polyoxypropylene cocamide, polypropylene glycol 2-hydroxyethyl isostearamide and polypropylene glycol 2-hydroxyethyl cocamide. It is prepared, for example, by polyalkoxylation (e.g., addition of ethylene oxide or propylene oxide) of fatty acid monoalkanolamide or amidation of fatty acid with polyalkylene glycol.

The content of the polyoxyalkylene alkanolamide surfactant in the herbicidal composition of the present invention is generally 0.1% to 30% by weight, preferably 0.1% to 20% by weight.

The aromatic hydrocarbon is generally a solvent that can dissolve clethodim. Namely, the aromatic hydrocarbon is usually used in the amount that can dissolve the clethodim contained in the herbicidal composition.

Examples of the aromatic hydrocarbon include xylene, phenylxylylethane, Hisol SAS-296 (a mixture of 1-phenyl-1-xylylethane and 1-phenyl-1-ethylphenylethane, commercial name of Nippon Petroleum Company), Cactus Solvent HP-DMN (containing 80% of dimethylnaphthalene, commercial name of Nikko Petrochemical Company), Cactus Solvent P-100 (alkylbenzene having 9 to 10 of carbon number, commercial name of Nikko Petrochemical Company), Aromatic 150 (aromatic hydrocarbon, commercial name of ExxonMobil Chemical) and Aromatic 200 (aromatic hydrocarbon, commercial name of ExxonMobil Chemical).

The content of the aromatic hydrocarbon in the herbicidal composition of the present invention is generally 10% to 89.8% by weight.

Further, the herbicidal composition optionally comprises the other solvent, auxiliaries such as esters of fatty acid, antioxidant, fungicide, perfume, dyestuff, and so on.

The esters of fatty acid are generally can work as enhancer of bioefficacy. The formula of esters of fatty acid is RCOOR′; wherein R is an alkyl group having 7 to 21 carbon atoms or an alkenyl group having 7 to 21 carbon atoms, and R′ is an alkyl group having 1 to 8 carbon atoms. Examples of the group given by the formula RCO include palmitoyl, myristoyl, stearoyl, lauroyl and oleoyl. Examples of R′ are methyl, ethyl, isopropyl, butyl, isobutyl and octyl. Typical examples of the esters of fatty acid are methyl oleate, methyl palmitate, methyl laurate, isopropyl myristate, isopropyl palmitate, octyl laurate, octyl palmitate and butyl stearate.

When the ester of fatty acid is used, the content of the ester of fatty acid in the herbicidal composition is generally 0.1% to 79.8% by weight, preferably 10% to 50% by weight. In addition, when the ester of fatty acid is used, the content of the aromatic hydrocarbon in the herbicidal composition of the present invention is preferably 10% to 60% by weight.

Preferably, propyl gallate is used for antioxidant; the content of the propyl gallate in the herbicidal composition is generally 0.01% to 10% by weight, preferably 0.1% to 3% by weight.

The herbicidal composition of the present invention can be prepared by mixing i) clethodim, ii) a sulfonate surfactant, iii) a polyoxyalkylene alkanolamide surfactant and iv) an aromatic hydrocarbon, and optionally the other solvent, auxiliaries and so on.

The herbicidal composition of the present invention is utilized as an emulsifiable concentrate in general, namely it is diluted with water to give an emulsion and applied to weeds, especially graminaceous weeds such as Agropyron tsukushiense, barnyardgrass (Echinochloa crus-galli), green foxtail (Setaria viridis), giant foxtail (Setaria faheri), large crabgrass (Digitaria sanguinalis), annual bluegrass (Poa annua), blackgrass (Alopecurus myosuroides), oats (Avena sativa), wild oats (Avena fatua), johnsongrass (Sorghum halepense), quackgrass (Agropyron repens), downy brome (Bromus tectorum) and bermudagrass (Cynodon dactylon) in broad-leaf crop (e.g. soybean, cotton, sugarbeet, peanut) fields. The application dosage is generally 10 g to 1000 g per hectare in the amount of clethodim, although it may vary with the kinds of objective weeds, weather conditions and so on. The dilution of the herbicidal composition can also be used for aerial application by helicopter, plane or radio-controlled helicopter. The herbicidal composition of the present invention may be diluted with water containing a spreading agent. Examples of the spreading agent include Agridex (commercial name of Helena Chemical Corporation), Dynamic (commercial name of Helena Chemical Corporation), Induce (commercial name of Helena Chemical Corporation) and Silwet L-77 (manufactured by Nihon Unicar).

### EXAMPLES

Hereinafter, the present invention is explained in more detail referring to examples, but the present invention should not be limited in the following examples.

### Example 1

The following ingredients were thoroughly mixed to give
a herbicidal composition of the present invention.

| | |
|---|---|
| Clethodim (purity: 93%) | 13.50 wt % |
| Calcium dodecylbenzenesulfonate | 3.34 wt % |
| (60% calcium dodecylbenzenesulfonate in | |
| 2-ethylhexanol, Agnique ABS 60C supplied by Cognis) | |
| Polyoxyethylene lauramide (NINOL L-5 supplied by | 2.00 wt % |
| Stepan) | |
| Aromatic 150 (aromatic hydrocarbon, commercial name | 81.16 wt % |
| of ExxonMobil Chemical) | |

### Example 2

The following ingredients were thoroughly mixed to give
a herbicidal composition of the present invention.

| | |
|---|---|
| Clethodim (purity: 93%) | 13.50 wt % |
| Calcium dodecylbenzenesulfonate | 3.34 wt % |
| (60% calcium dodecylbenzenesulfonate in | |
| 2-ethylhexanol, Agnique ABS 60C supplied by Cognis) | |
| Polyoxyethylene lauramide (NINOL L-5 supplied by | 2.00 wt % |
| Stepan) | |
| Methyl oleate (Agnique ME 181-U supplied by Cognis) | 40.00 wt % |
| Aromatic 150 (aromatic hydrocarbon, commercial name | 41.16 wt % |
| of ExxonMobil Chemical) | |

### Example 3

The following ingredients were thoroughly mixed to give
a herbicidal composition of the present invention.

| | |
|---|---|
| Clethodim (purity: 93%) | 13.50 wt % |
| Calcium dodecylbenzenesulfonate | 1.67 wt % |
| (60% calcium dodecylbenzenesulfonate in | |
| 2-ethylhexanol, Agnique ABS 60C supplied by Cognis) | |
| Polyoxyethylene cocamide (NINOL 1301 supplied by | 9.00 wt % |
| Stepan) | |
| Aromatic 150 (aromatic hydrocarbon, commercial name | 75.83 wt % |
| of ExxonMobil Chemical) | |

### Example 4

The following ingredients were thoroughly mixed to give
a herbicidal composition of the present invention.

| | |
|---|---|
| Clethodim (purity: 93%) | 13.50 wt % |
| Calcium dodecylbenzenesulfonate | 1.67 wt % |
| (60% calcium dodecylbenzenesulfonate in | |
| 2-ethylhexanol, Agnique ABS 60C supplied by Cognis) | |
| Polyoxyethylene cocamide (NINOL 1301 supplied by | 9.00 wt % |
| Stepan) | |
| Methyl oleate (Agnique ME 181-U supplied by Cognis) | 40.00 wt % |
| Aromatic 150 (aromatic hydrocarbon, commercial name | 35.83 wt % |
| of ExxonMobil Chemical) | |

### Test Example 1

342 ppm hard water (obtained by dissolving 3.04 g of anhydrous calcium chloride and 0.139 g of magnesium chloride hexahydrate in distilled water and making up to 1 litter) was charged in a 95 ml-cylinder with lid, and keep at room temperature. Then 5 ml of each of the compositions obtained in Examples 1 to 4 was added. The cylinders were inverted 10 times in 20 seconds. After keeping the cylinders for two hours at room temperature, the separation of the top layer was observed as emulsion stability.

| | |
|---|---|
| 1 | excellent |
| 2 | acceptable |
| 3 | excellent |
| 4 | excellent |

We claim:

1. A herbicidal composition which comprises clethodim, a sulfonate surfactant, a polyoxyalkylene alkanolamide surfactant and an aromatic hydrocarbon.

2. The herbicidal composition according to claim 1, which comprises 5% to 40% by weight of clethodim, 0.1% to 10% by weight of a sulfonate surfactant, 0.1% to 30% by weight of a polyoxyalkylene alkanolamide surfactant and 10 to 89.8% by weight of an aromatic hydrocarbon.

3. The herbicidal composition according to claim 1, which comprises 10% to 30% by weight of clethodim, 0.1% to 5% by weight of a sulfonate surfactant, 0.1% to 20% by weight of a polyoxyalkylene alkanolamide surfactant and 10 to 89.8% by weight of an aromatic hydrocarbon.

4. The herbicidal composition according to claim 1, which comprises clethodim, a sulfonate surfactant, a polyoxyalkylene alkanolamide surfactant and an aromatic hydrocarbon and an ester of fatty acid.

5. The herbicidal composition according to claim 4, which comprises 5% to 40% by weight of clethodim, 0.1% to 10% by weight of a sulfonate surfactant, 0.1% to 30% by weight of a polyoxyalkylene alkanolamide surfactant, 10% to 89.8% by weight of an aromatic hydrocarbon and 0.1% to 79.8% by weight of an ester of fatty acid.

6. The herbicidal composition according to claim 4, which comprises 10% to 30% by weight of clethodim, 0.1% to 5% by weight of a sulfonate surfactant, 0.1% to 20% by weight of a polyoxyalkylene alkanolamide surfactant, 10% to 60% by weight of an aromatic hydrocarbon and 10% to 50% by weight of an ester of fatty acid.

7. The herbicidal composition according to claim 6, wherein the ester of fatty acid is methyl oleate.

8. The herbicidal composition according to any of claims 1-7, wherein the sulfonate surfactant is a salt of dodecylbenzenesulfonic acid.
